(19) United States
(12) Patent Application Publication
(10) Pub. No.: US 2013/0249807 A1
(43) Pub. Date: Sep. 26, 2013

(54) METHOD AND APPARATUS FOR THREE-DIMENSIONAL IMAGE ROTATION ON A TOUCH SCREEN

(71) Applicant: Tuming You, Xiamen (CN)

(72) Inventor: Tuming You, Xiamen (CN)

(21) Appl. No.: 13/425,680

(22) Filed: Mar. 21, 2012

(51) Int. Cl. G06F 3/041; G06T 15/00

(52) U.S. Cl. 345/173

(57) ABSTRACT

A method and apparatus for three-dimensional image rotation involves detection of finger motion on or near a touch screen and comparison of the detected movement to one or more predetermined trajectories over the display area of the touch screen. The predetermined trajectories can be an arc and two substantially parallel lines. When the detected movement is determined to correspond with a predetermined trajectory, a changed three-dimensional image is displayed showing rotation of the image subject.

### FIELD OF THE INVENTION

This invention relates generally to electronic devices having a touch-sensitive screen as a user interface and, more particularly, a method, electronic device, and computer readable medium for three-dimensional image rotation on a touch touch-sensitive screen.

### BACKGROUND OF THE INVENTION

With the growing popularity of portable electronic devices, there are increasing demands placed by consumers on the functionality of portable electronic devices. In response to such demands, touch sensitive displays screens have been developed. With finger taps and movements on the touch sensitive display screen, users are able to interact with portable electronic devices without a conventional push-button keyboard and mouse input device. The phrases “touch sensitive display screen,” “touch sensitive screen,” and “touch screen” are used interchangeably herein.

Most common portable electronic devices, such as smart phones and tablet personal computers have applications for viewing images and browsing documents. Operations such as pan and zoom can be performed by the user's finger(s) making contact with the touch screen. For example, a pan operation is commonly be performed by a single point contact of one finger translated across the touch screen. Also, a zoom operation is commonly performed by a double point contact of two fingers moving toward or away from each other along two travel paths having a colliding or intersecting trajectory.

Three-dimensional (3D) image rotation is useful function in many applications, such as 3D modeling, viewing, and gaming. What is needed is a convenient and efficient way for a user to rotate an image subject using one or more types of motions distinct from motions for pan, zoom, and other functions.

### SUMMARY OF THE INVENTION

Briefly and in general terms, the present invention is directed to rotational display of a three-dimensional image on a touch screen. In aspects of the invention, a method comprises displaying, on a touch screen of an electronic device, an initial three-dimensional image of an image subject. The method further comprises, detecting motion of at least one object in contact with the touch screen, the detecting step performed by the electronic device. The method further comprises, comparing the detected motion to a predetermined trajectory. The method further comprises, when the detected motion corresponds to the predetermined trajectory, displaying a changed three-dimensional image on the touch screen, the changed three-dimensional image showing rotation of the image subject relative to the initial three-dimensional image.

In aspects of the invention, an electronic device comprises a memory device storing three-dimensional image data, a touch screen, and a processor. The processor is in signal communication with the touch screen and the memory device. The processor is configured to execute instructions to display on the touch screen an initial three-dimensional image of an image subject based on the three-dimensional image data stored in the memory device, execute instructions to detect motion of at least one object in contact with the touch screen, execute instructions to compare the detected motion to a predetermined trajectory, and execute instructions to display a changed three-dimensional image on the touch screen. The changed three-dimensional image shows rotation of the image subject relative to the initial three-dimensional image.

In aspects of the present invention, a non-transitory computer readable medium has a stored computer program embodying instructions, which when executed by a computer, causes the computer to drive a touch screen. The computer readable medium comprises instructions for displaying on the touch screen an initial three-dimensional image of an image subject, instructions for detecting motion of at least one object in contact with the touch screen, instructions for comparing the detected motion to a predetermined trajectory; and instructions for displaying a changed three-dimensional image on the touch screen, the changed three-dimensional image showing rotation of the image subject relative to the initial three-dimensional image.

The features and advantages of the invention will be more readily understood from the following detailed description which should be read in conjunction with the accompanying drawings.

### BRIEF DESCRIPTION OF THE DRAWINGS

FIG. 1 is a block diagram of an exemplary apparatus for displaying a three-dimensional image.

FIG. 2 is flow diagram of an exemplary method for displaying a three-dimensional image, including rotation of the image.

FIGS. 3A and 3B are diagrams of exemplary motions, for a finger or other object, used for three-dimensional image rotation on a touch screen.

FIGS. 4A-4C are diagrams of exemplary motions, for two fingers or other objects, used for three-dimensional image rotation on a touch screen.

FIGS. 5A-5C are diagrams of exemplary motions used for three-dimensional image rotation, zoom, and panning

### DETAILED DESCRIPTION OF EXEMPLARY EMBODIMENTS

As used herein, any term of approximation such as, without limitation, near, about, approximately, substantially, essentially and the like mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the modified word or phrase. For example and without limitation, a first element that is described as “substantially parallel” in reference to a second element encompasses an orientation that is perfectly parallel and an orientation that one skilled in the art would readily recognize as being parallel even though distances between corresponding locations on the two respective structures are not exactly the same.

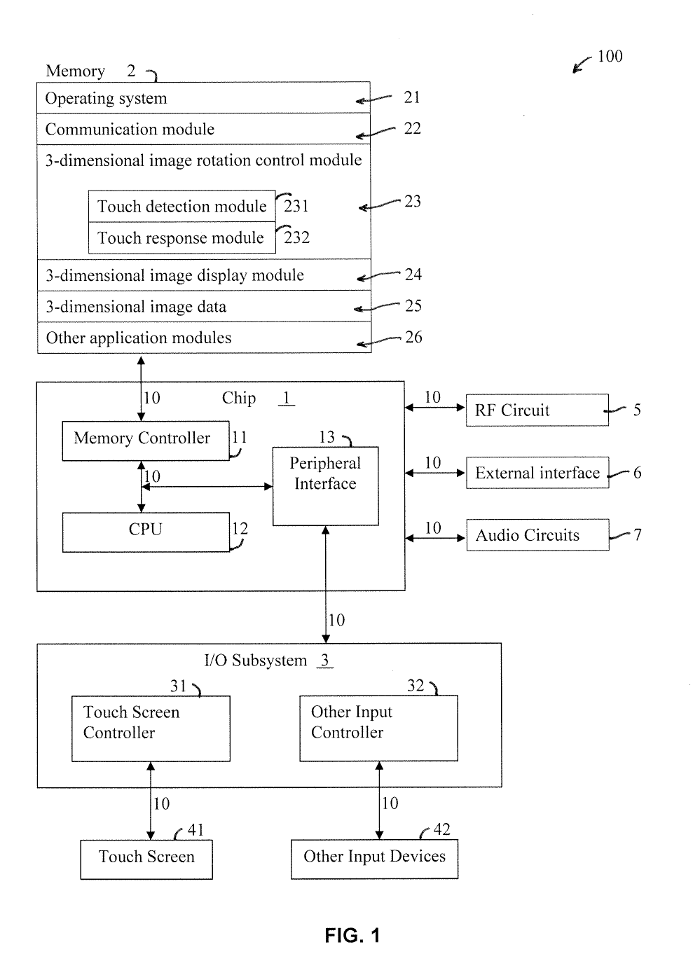

Referring now in more detail to the exemplary drawings for purposes of illustrating embodiments of the invention, wherein like reference numerals designate corresponding or like elements among the several views, there is shown in FIG. 1 an exemplary apparatus 100 for rotating a three-dimensional image on a touch-sensitive screen 41 of the apparatus.

Apparatus 100 can be a smart phone, electronic tablet, personal digital assistant, personal computer, or part of a larger system, such as a navigation system of vehicle. A smart phone is a mobile phone built on a mobile computing platform that allows the smart phone to have, in addition to telecommunications, any one of a combination of features including without limitation a media player, digital camera, web browser, global positioning system navigation, Wi-Fi and other wireless data communication.

Other hardware configurations for apparatus 100 are within the scope of the invention. It is to be understood that the present invention encompasses any apparatus having a touch screen and configured to display a three-dimensional image on the touch screen as described below.

As used herein, a three-dimensional image is a graphical representation of a subject (also referred to as “image subject”) that gives the subject the appearance of depth, in addition to width and height, when displayed on touch screen 41. A three-dimensional image of a subject can be, for example and without limitation, a perspective view of the subject or an orthographic view of the subject. The image subject can be any anything, being real or virtual.

Referring again to FIG. 1, apparatus 100 further includes chip 1, memory 2 and input/output (I/O) subsystem 3. Chip 1 includes memory controller 11, processor (CPU) 12, and peripheral interface 13. Memory 2 is a single or multiple coupled volatile (transitory) and non-volatile (non-transitory) memory devices, including without limitation magnetic disk storage devices, flash memory devices, and other non-volatile solid-state memory. Software programs and image data are stored in memory 2. Software programs include operating system 21, communication module 22, three-dimensional image rotation control module 23, three-dimensional image display module 24, three-dimensional image data 25, other application modules 26. I/O subsystem 3 includes touch screen controller 31 and other input controller 32. Chip 1 is connected to the RF circuit 5, external interface 6 and audio circuit 7. I/O subsystem 3 is connected to touch screen 41 and other input devices 42. Connections through signal bus 10 allow each of the above components to communicate with each other through any combination of a physical electrical connection and a wireless communication connection.

In alternative embodiments, any one or a combination of memory controller 11, processor 12, and peripheral interface 13 can be implemented in multiple, separate chips instead of a single chip. In some embodiments, some or all of memory 2 can be implemented on a single chip with any one or a combination of memory controller 11, processor 12, and peripheral interface 13.

Touch screen 41 is an electronic visual display configured to detect the presence, location, and movement of a physical object within the display area of the touch screen 41. The display area is that part of the touch screen 41 on which images are shown. The physical object can be a finger, a stylus, or other utensil manipulated by a person using apparatus 100. Object detection can be performed according to various technologies. Object detection can be accomplished with resistive, acoustic, infrared, near-infrared, vibratory, optical, surface capacitance, projected capacitance, mutual capacitance, and self-capacitance screen technologies. For example, detecting the presence, location, and movement of a physical object within the display area can include sensing a distortion of an electrostatic field of the screen, measurable as a change in capacitance due to physical contact with a finger or other electrical conductor. As a further example, object detection can include sensing disruption of a pattern or grid of electromagnetic beams without any need for actual physical contact with or touching of the display area.

Memory 2 stores three-dimensional image data 25 used to display a three-dimensional image on touch screen 41. Three-dimensional image display module 24 controls the display of the three-dimensional image on touch screen 41. Three-dimensional image rotation control module 23 includes a touch detection module 231 and touch response module 232. Touch detection module 231 includes instructions for detecting the presence, location, and movement of a physical object within the display area of touch screen 41. Touch response module 232 includes instructions for making one or more images or an animation of the three-dimensional image showing rotation of the image subject in response to a detection made by processor 12 in conjunction with touch detection module 231. Processor 12 includes one or more processors configured to execute the instructions for the above-described functions. Any one or a combination of the instructions for the above-described functions may be stored in a non-volatile (non-transitory) computer readable storage medium or a random access (transitory) computer readable storage medium of memory 2 accessible for execution by processor 12.

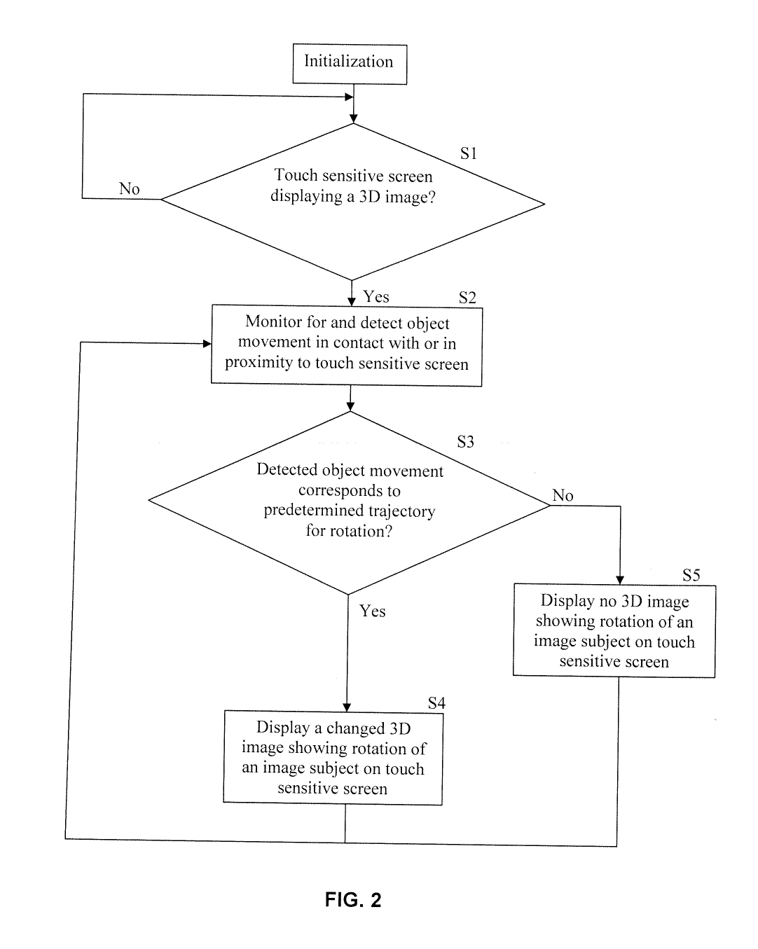

FIG. 2 shows a flow diagram of an exemplary method for three-dimensional image rotation on a touch sensitive display. Although the exemplary method is described in connection with apparatus 100 of FIG. 1, it will be appreciated that other devices may be used implement the method.

After initialization, processor 12 executes instructions, which may optionally be stored in non-volatile and/or random access computer readable storage media of memory 2, to allow apparatus 100 to perform the following functions. Apparatus 100 determines whether touch screen 41 is displaying a three-dimensional image (step S1). If not, steps S2, S3, and S4 below are not performed by apparatus 100. If yes, apparatus 100 monitors for and detects movement (step S2) of an object in contact with touch screen 41. Next, apparatus 100 determines whether the detected movement corresponds to a predetermined trajectory by comparing (step S3) the detected movement to the predetermined trajectory. When the detected movement is determined to corresponds to a predetermined trajectory, apparatus 100 makes a changed three-dimensional image by applying a rotational change to the initial three-dimensional image. The changed three-dimensional image is displayed (step S4) on touch screen 41 and shows a rotation of the image subject relative to the initial three-dimensional image. When the detected movement is determined to not correspond to a predetermined trajectory, apparatus 100 makes no rotational change to the initial three-dimensional image displayed on the touch screen. No three-dimensional image is displayed (step S5) that would show rotation of the image subject relative to the initial three-dimensional image.

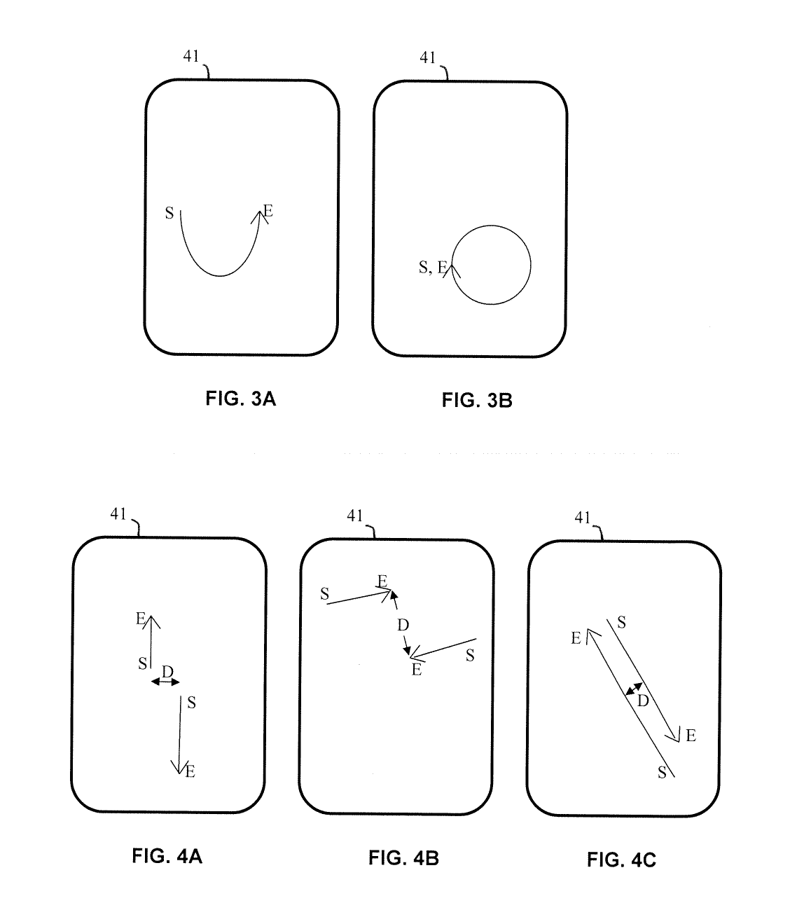

Exemplary movements of an object in contact with touch screen 41 are shown in FIGS. 3A and 3B. The movements have start point S and end point E. The illustrated movements correspond to a predetermined trajectory in the form of an arc progressing across touch screen 41. FIGS. 3A and 3B show non-limiting examples of arc types. The arc can be a portion of a circle or a portion of an ellipse (FIG. 3A). The arc can be a complete circle (FIG. 3B) or a complete ellipse. The arc can be a parabolic curve, a spiral curve, or other type of curve.

Exemplary movements of two objects in contact with touch screen 41 are shown in FIGS. 4A-4C. The movements have start point S and end point E. The movements in FIGS. 4A-4C correspond to a predetermined trajectory in the form of two substantially parallel lines progressing simultaneously in opposite directions across touch screen 41. The parallel lines are offset from each other by distance D measured at a spot where the moving objects are closest to each other and measured in a direction substantially perpendicular to the parallel lines. The possibility of a collision between the two objects is avoided with offset distance D.

There is substantially no offset distance associated with pinch and unpinch movements. A pinch movement is that in which two objects follow a collision course. An unpinch movement is the reverse of a pinch movement. When an unpinch movement is performed in reverse, the two objects would be on a collision course.

FIGS. 4A-4C show non-limiting examples of two-line progression types for simultaneous contacts that can produce substantially parallel lines. The two simultaneous contacts can move apart from each other (FIG. 4A), move closer to each other (FIG. 4B), or move closer to each other and then move apart from each other (FIG. 4C). As shown in FIG. 4C, the substantially parallel movements can have different lengths between start point S and end point E. The two simultaneous contacts can move at different speeds.

In some embodiments, processor 12 executes instructions including one or more criteria that encompasses a plurality of arc types so that detected movement corresponding to any one of the plurality of arc types will result in performance of step S4. In some embodiments, processor 12 executes instructions having one or more criteria that encompasses a plurality of two-line progression types so that detected movement corresponding to any one of the plurality of two-line progression types will result in performance of step S4. In some embodiments, processor 12 executes instructions including one or more criteria that encompasses one or more arc types and one or more two-line progression types, so that detected movement corresponding to any one of the arc types and two-line progression types will result in performance of step S4.

The direction of rotational change in step S4 can be based on the position of the object movement start point S and end point E on touch screen 41 relative to the three-dimensional image displayed on touch screen 41.

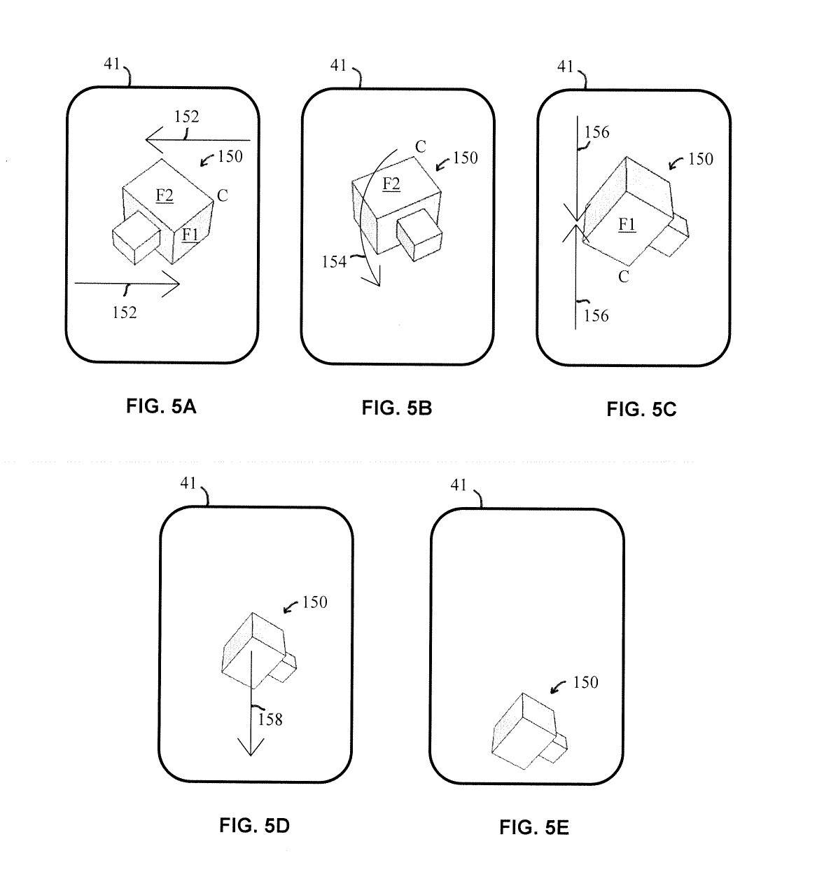

An exemplary method according to the present invention is shown in FIGS. 5A-5D. Processor 12 executes instructions, which may optionally be stored in non-volatile and/or random access computer readable storage media of memory 2, to allow apparatus 100 to perform the functions described below in connection with FIGS. 5A-5D.

FIG. 5A shows an initial three-dimensional image of image subject 150. Image subject 150 is a block having corner C, first face F1, and second face F2. Two arrows 152 represent the simultaneous movement of two objects, such as a thumb and index finger, corresponding to substantially parallel lines across touch screen 41. Processor 12 detects the movements, determines that they correspond to a predetermined trajectory for rotation. In response to the positive determination, processor 12 applies a rotational change to the initial three-dimensional image to make a changed three-dimensional image, and displays the changed three-dimensional image on touch screen 41 shown in FIG. 5B. The changed three-dimensional image shows rotation of image subject 150 relative to its orientation in the initial three-dimensional image of FIG. 5A. Face F1 was rotated out of view so that it appears to be hidden or blocked from view by face F2.

The changed three-dimensional image in FIG. 5B can now be referred to as an initial three-dimensional image with respect to subsequent operations. Arrow 154 represents movement of a single object, such as one finger, corresponding to an arc across touch screen 41. Processor 12 detects the movement and determines that it corresponds to a predetermined trajectory for rotation. In response to the positive determination, processor 12 applies a rotational change to the initial three-dimensional image of FIG. 5B to make a changed three-dimensional image, and displays the changed three-dimensional image on touch screen 41 shown in FIG. 5C. The changed three-dimensional image shows rotation of image subject 150 relative to its orientation in the initial three-dimensional image of FIG. 5B. Face F1 was rotated into view so that it is visible again. Face F2 was rotated out of view so that it appears to be hidden or blocked from view by face F1.

The changed three-dimensional image in FIG. 5C can now be referred to as an initial three-dimensional image with respect to subsequent operations. Two arrows 156 represent a pinch movement by two objects, such as a thumb and index finger, corresponding to colliding paths across touch screen 41. The colliding paths have no offset distance. Processor 12 detects the pinch movement, determines that it corresponds to a predetermined trajectory for zoom out. In response to the positive determination, processor 12 applies a scale change to the initial three-dimensional image of FIG. 5C. The scale change results in a changed three-dimensional on touch screen 41 shown in FIG. 5D. The changed three-dimensional image shows a reduction in size of image subject 150 without rotation.

The changed three-dimensional image in FIG. 5D can now be referred to as an initial three-dimensional image with respect to subsequent operations. Arrow 158 represents a pan movement of one object, such as a finger, corresponding to substantially straight line across touch screen 41. Processor 12 detects the pan movement, determines that it corresponds to a predetermined trajectory for panning. In response to the positive determination, processor 12 applies a linear translation change to the initial three-dimensional image of FIG. 5D. The linear translation change results in a changed three-dimensional image on touch screen 41 shown in FIG. 5E. The changed three-dimensional image shows a linear change in position of image subject 150 without rotation.

It should be understood that FIGS. 5A-5C show image subject 150 from different points of view or different viewing directions. FIGS. 5C-5E show image subject 150 from the same viewing direction.

An animation, which may include a series of progressively changed images, can be displayed on touch screen 14 as a transition between FIGS. 5A and 5B, between FIGS. 5B and 5C, between FIGS. 5C and 5D, and between FIGS. 5D and 5E.

It will be appreciated that the above described method embodiments and associated processor executed instructions can be performed without contacting a touch screen configured to detect proximity of an object, such as by using a grid of electromagnetic beams arranged in front of the touch screen display area.

It will be appreciated that the present invention provides convenient finger or stylus movements to rotationally display a three-dimensional image on a touch screen without the use of conventional keyboards, wheels, tracking balls, and mouse pointers. The finger or stylus movements for three-dimensional image rotation are distinct from and can be used together with other types of finger movements for image panning and zoom. The present invention can thus greatly expand the functionality of smart phones, tablet PCs, other portable electronic devices to include three-dimensional modeling, viewing, and gaming.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A method for rotational display of a three-dimensional image on a touch screen, the method comprising:
displaying, on a touch screen of an electronic device, an initial three-dimensional image of an image subject;
detecting motion of at least one object in contact with the touch screen, the detecting step performed by the electronic device;
comparing the detected motion to a predetermined trajectory; and
when the detected motion corresponds to the predetermined trajectory, displaying a changed three-dimensional image on the touch screen, the changed three-dimensional image showing rotation of the image subject relative to the initial three-dimensional image.

2. The method of claim 1, wherein the predetermined trajectory includes an arc progressing across the touch screen.

3. The method of claim 2, wherein the at least one object is a finger.

4. The method of claim 1, wherein the predetermined trajectory includes two substantially parallel lines progressing in opposite directions across the touch screen.

5. The method of claim 4, wherein the at least one object are two fingers.

6. The method of claim 1, wherein the displaying of the changed three-dimensional image includes displaying an animated rotation of the image subject on the touch screen.

7. The method of claim 1, wherein when the detected motion does not correspond to the predetermined trajectory, displaying no three-dimensional image showing rotation of the image subject relative to the initial three-dimensional image.

8. The method of claim 1, wherein the electronic device is a smart phone.

9. The method of claim 1, wherein the electronic device is a tablet personal computer.

10. An electronic device for rotational display of a three-dimensional image, the electronic device comprising:
a memory device storing three-dimensional image data;
a touch screen; and
a processor in signal communication with the touch screen and the memory device, the processor configured to execute instructions to display on the touch screen an initial three-dimensional image of an image subject based on the three-dimensional image data stored in the memory device, execute instructions to detect motion of at least one object in contact with the touch screen, execute instructions to compare the detected motion to a predetermined trajectory, and execute instructions to display a changed three-dimensional image on the touch screen, the changed three-dimensional image showing rotation of the image subject relative to the initial three-dimensional image.

11. The electronic device of claim 10, wherein the predetermined trajectory includes an arc progressing across the touch screen.

12. The electronic device of claim 10, wherein the predetermined trajectory includes two substantially parallel lines progressing in opposite directions across the touch screen.

13. The electronic device of claim 10, wherein the instructions to display the changed three-dimensional image include instructions to display an animated rotation of the image subject on the touch screen.

14. The electronic device of claim 10, wherein the instructions to compare the detected motion to a predetermined trajectory are stored in a non-transitory component of the memory device, and the predetermined trajectory is at least one of an arc progressing across the touch screen and a pair of substantially parallel lines progressing in opposite directions across the touch screen.

15. The electronic device of claim 10, wherein the instructions to display the changed three-dimensional image are stored in a non-transitory component of the memory device.

16. A non-transitory computer readable medium having a stored computer program embodying instructions, which when executed by a computer, causes the computer to drive a touch screen, the computer readable medium comprising:
instructions for displaying on the touch screen an initial three-dimensional image of an image subject;
instructions for detecting motion of at least one object in contact with the touch screen;
instructions for comparing the detected motion to a predetermined trajectory; and
instructions for displaying a changed three-dimensional image on the touch screen, the changed three-dimensional image showing rotation of the image subject relative to the initial three-dimensional image.

17. The computer readable medium of claim 16, wherein the predetermined trajectory includes an arc progressing across the touch screen.

18. The computer readable medium of claim 16, wherein the predetermined trajectory includes two substantially parallel lines progressing in opposite directions across the touch screen.

19. The computer readable medium of claim 16, wherein the instructions to display the changed three-dimensional image include instructions to display an animated rotation of the image subject on the touch screen.

20. The computer readable medium claim 16, further comprising instructions to display no three-dimensional image showing rotation of the image subject relative to the initial three-dimensional image when the detected motion does not correspond to the predetermined trajectory.
